(19) United States
(12) Patent Application Publication
(10) Pub. No.: US 2016/0109977 A1
(43) Pub. Date: Apr. 21, 2016

(54) TOUCH DISPLAY PANEL AND TOUCH DISPLAY APPARATUS

(71) Applicant: InnoLux Corporation, Miao-Li County (TW)

(72) Inventors: Kazuyuki Hashimoto, Miao-Li County (TW); Yun-Chung Huang, Miao-Li County (TW); Bo-Han Wu, Miao-Li County (TW)

(21) Appl. No.: 14/517,512

(22) Filed: Oct. 17, 2014

(51) Int. Cl. G06F 3/044; G06F 3/041

(52) U.S. Cl. CPC G06F 3/044; G06F 3/0412; G06F 2203/04103

(57) ABSTRACT

A touch display panel includes a substrate, a light-blocking matrix layer and a sensing circuit. The sensing circuit is disposed on a surface of the substrate and forms a single-layer structure and located at the light-blocking matrix layer. The sensing circuit includes a plurality of driving electrodes, a plurality of sensing electrodes and a plurality of signal wires. The driving electrodes and the sensing electrodes are insulated from each other. The signal wires are connected to the driving electrodes and the sensing electrodes. The sensing electrodes, the driving electrodes and the signal wires are disposed on the single-layer structure. A touch display apparatus is also disclosed.

### BACKGROUND OF THE INVENTION

1. Field of Invention

The invention relates to a touch display panel and a touch display apparatus and, in particular, to a touch display panel and a touch display apparatus where the sensing circuit is disposed on a side of the substrate and forms a single-layer structure.

2. Related Art

The touch technology applied to the touch display panel can be mainly divided into a capacitive type and a resistive type. For the past few years, the capacitive type of the touch display panel has a rising market share and thus has an opportunity to become the mainstream technology by surpassing the resistive type of the touch display panel. In the touch control of the capacitive sensing, the capacitance of the panel is changed to result in the current variation, and then the current variation is converted into voltage level variation so that the touch coordinates of the user can be determined.

The capacitive sensing touch display panel can be further divided into a single-layer capacitive touch display panel and a double-layer touch display panel. In the double-layer capacitive touch display panel, the two sensing electrode layers are disposed and an insulating material is disposed therebetween. Through the conductive patterns of the two sensing electrode layers which cross each other, the touch position of the user can be sensed and determined. However, the double-layer sensing electrode will make a higher process cost due to its complicated process.

By contrast, the single-layer capacitive touch display panel becomes a popular technology recently due to its advantages such as lightness, thinness, narrow border and low cost. Nevertheless, some problems still exist, such as high-dependency resistance and high RC loading.

### SUMMARY OF THE INVENTION

An objective of the invention is to provide a touch display panel and a touch display apparatus in which the sensing circuit forms a single-layer structure on a surface of the substrate.

A touch display panel disclosed by the invention comprises a substrate, a light-blocking matrix layer and a sensing circuit. The sensing circuit forms a single-layer structure on a surface of the substrate and located at the light-blocking matrix layer.

The sensing circuit includes a plurality of driving electrodes, a plurality of sensing electrodes and a plurality of signal wires. The driving electrodes and the sensing electrodes are insulated from each other. The signal wires are connected to the driving electrodes and the sensing electrodes. The sensing electrodes, the driving electrodes and the signal wires are disposed on the single-layer structure.

In one embodiment, a part of the signal wires has a branch.

In one embodiment, at least 70% of the area of the driving and sensing electrodes is located at the light-blocking matrix layer.

In one embodiment, a signal wire width of the driving electrodes, sensing electrodes and signal wires is between 3 μm and 50 μm. The driving electrodes and the sensing electrodes are arranged with a rectangular shape, “ [symbol] ” shape, comb shape or their any combination. The sensing electrodes, the driving electrodes and the signal wires are composed of a layout circuit located at the light-blocking matrix layer.

In one embodiment, the shape of the layout circuit includes an opening, a toothed shape, a lightning shape, a polygonal shape, a closed contour or their any combination, or occupies the all range of the light-blocking matrix layer. The pattern of the layout circuit includes a closed contour, an open curve, a net structure, a branched structure or their any combination.

In one embodiment, the material of the sensing circuit is gold, silver, copper, tin, molybdenum, aluminum, alloy, graphite, graphene or their any combination.

In one embodiment, the sensing circuit includes a plurality of grounding electrodes, which are disposed between and insulated from the driving electrodes and the sensing electrodes.

In one embodiment, the light-blocking matrix layer is disposed on another surface of the substrate.

In one embodiment, the light-blocking matrix layer is disposed on the surface of the substrate.

In one embodiment, the touch display panel further comprises a display panel, and the substrate is disposed on a light input side of the display panel.

A touch display apparatus disclosed by the invention comprises a touch display panel as mentioned above, a backlight module and at least a control unit. The backlight module is disposed on a side of the touch display panel. The control unit is electrically connected to the sensing circuit.

A touch display panel disclosed by the invention comprises a substrate, a light-blocking matrix layer and a sensing circuit. The sensing circuit forms a single-layer structure on a surface of the substrate. The sensing circuit includes a plurality of sensing electrodes. The sensing electrode includes a plurality of connecting wires, and at least one node is formed by connecting three of the connecting wires.

In one embodiment, any two included angles formed by the three connecting wires are different.

In one embodiment, the plurality of connecting wires includes a broken wire between two adjacent nodes.

As mentioned above, in the touch display panel and touch display apparatus of the invention, the single-layer sensing circuit is formed at the light-blocking matrix layer, so the area of the sensing circuit can be increased without increasing the light penetration loss. Therefore, the sensitivity of the touch display panel and apparatus can be enhanced, the whole RC loading can be reduced and the entire efficiency can be enhanced.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic sectional diagram of a touch display apparatus of an embodiment of the invention;

FIG. 2 is a schematic diagram of a part of a touch display panel of an embodiment of the invention;

FIG. 3A is a schematic diagram showing the sensing circuit of a touch display panel of an embodiment of the invention;

FIG. 3B is a schematic enlarged diagram of a part of FIG. 3A;

FIG. 4A is a schematic diagram of another embodiment of the sensing circuit of the touch display panel in FIG. 2;

FIG. 4B is a schematic diagram of another embodiment of the sensing circuit of the touch display panel in FIG. 2;

FIG. 4C is a schematic diagram of another embodiment of the sensing circuit of the touch display panel in FIG. 2;

FIG. 4D is a schematic diagram of another embodiment of the sensing circuit of the touch display panel in FIG. 2;

FIG. 4E is a schematic diagram of another embodiment of the sensing circuit of the touch display panel in FIG. 2;

FIG. 4F is a schematic diagram of another embodiment of the sensing circuit of the touch display panel in FIG. 2;

FIG. 4G is a schematic diagram of another embodiment of the sensing circuit of the touch display panel in FIG. 2;

FIG. 4H is a schematic diagram of another embodiment of the sensing circuit of the touch display panel in FIG. 2;

FIG. 4I is a schematic diagram of another embodiment of the sensing circuit of the touch display panel in FIG. 2;

FIG. 5 is a schematic sectional diagram of another embodiments of the touch display apparatus of the invention; and

FIG. 6 is a schematic sectional diagram of another embodiments of the touch display apparatus of the invention.

FIG. 7 is a schematic enlarged diagram of a part of the sensing circuit of the touch display panel according to another embodiment of the invention;

FIG. 8 is a schematic diagram of the sensing circuit of the touch display panel according to another embodiment of the invention;

FIG. 9 is a schematic diagram of the sensing circuit of the touch display panel according to another embodiment of the invention; and

FIG. 10 is a schematic diagram of the sensing circuit of the touch display panel according to another embodiment of the invention.

### DETAILED DESCRIPTION OF THE INVENTION

The present invention will be apparent from the following detailed description, which proceeds with reference to the accompanying drawings, wherein the same references relate to the same elements.

To be noted, the all embodiments shown in the figures are just for the illustrative purpose but not for representing the actual dimensions and ratios.

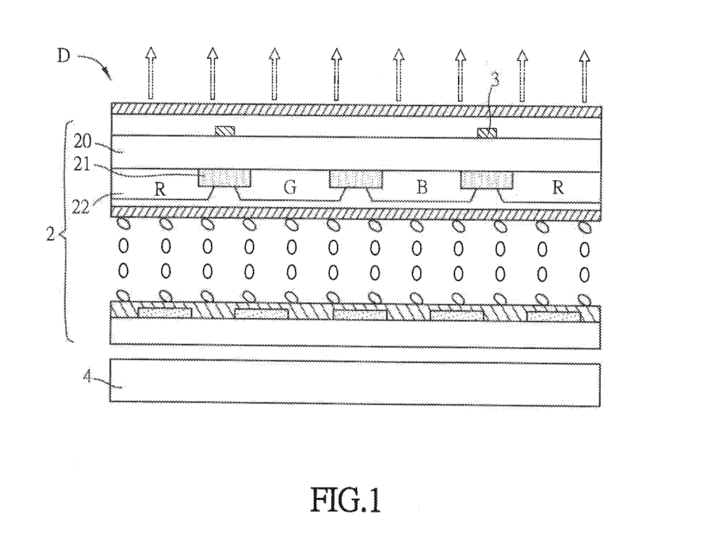

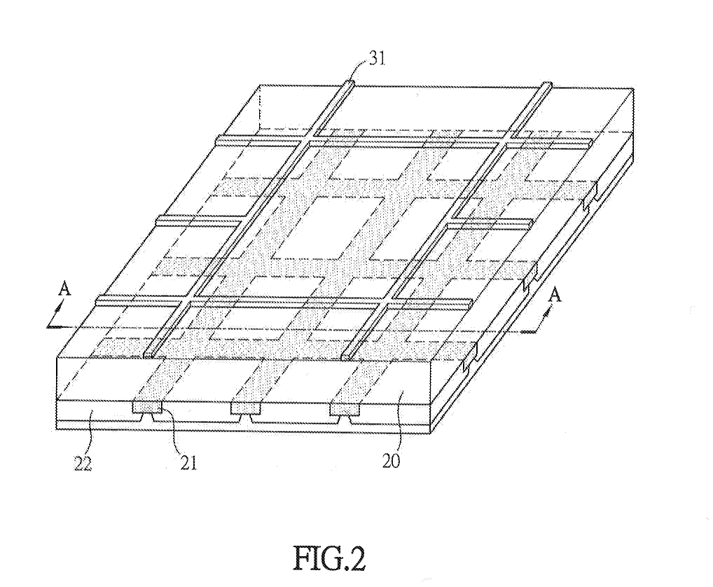

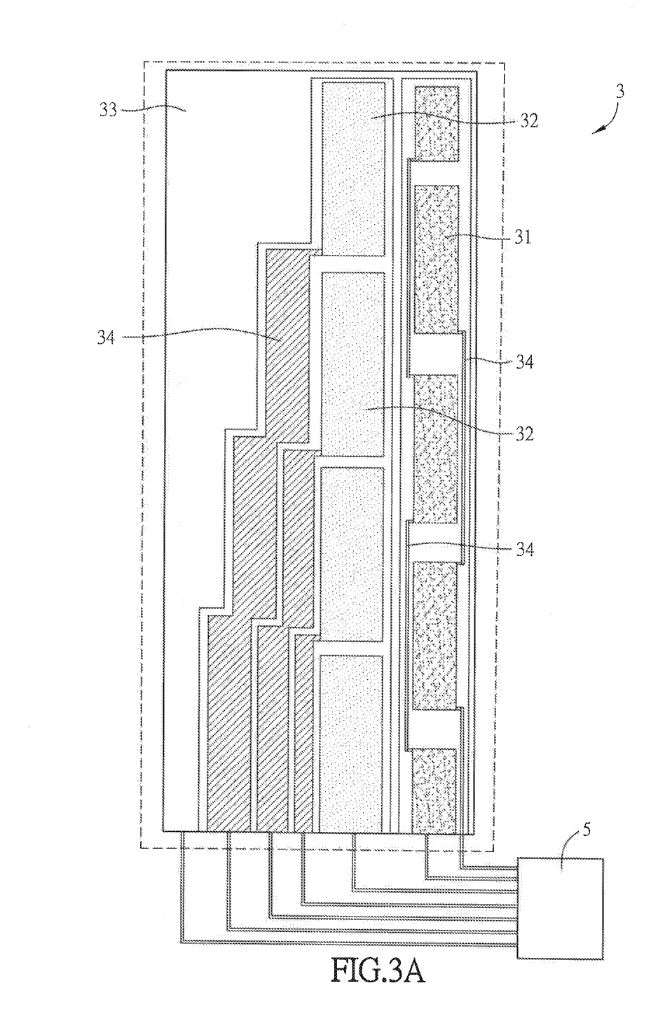

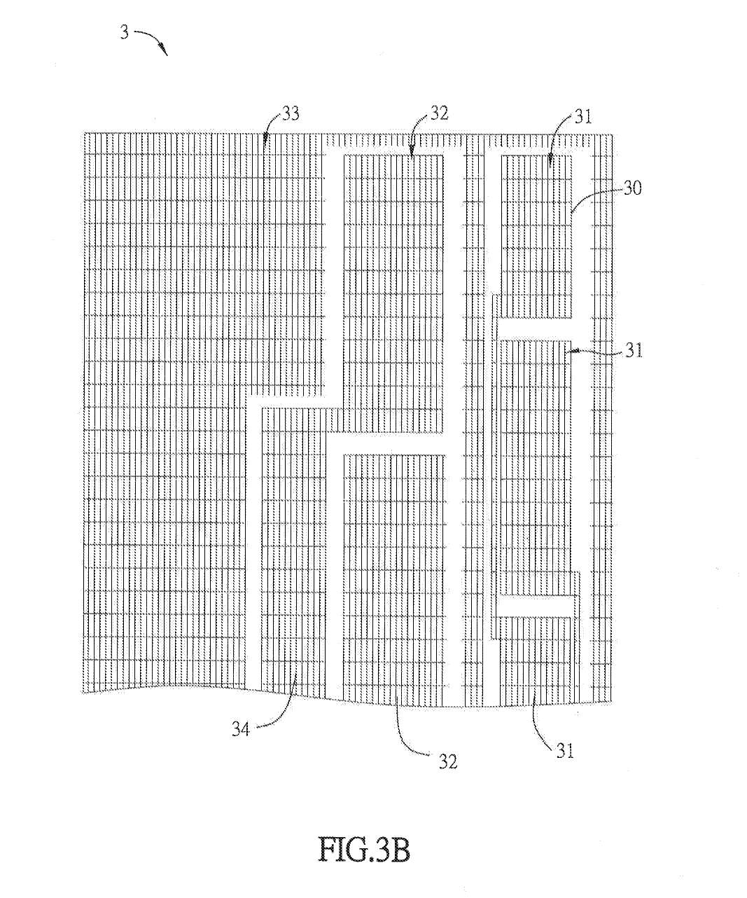

FIG. 1 is a schematic sectional diagram of a touch display apparatus of an embodiment of the invention, FIG. 2 is a schematic diagram of a part of a touch display panel of an embodiment of the invention, FIG. 3A is a schematic diagram showing the sensing circuit of a touch display panel of an embodiment of the invention, and FIG. 3B is a schematic enlarged diagram of a part of the sensing circuit in FIG. 3A.

As shown in FIGS. 1, 2, 3A and 3B, the touch display apparatus D of this embodiment includes a touch display panel 2, a backlight module 4 and at least a control unit 5. The touch display panel 2 includes a substrate 20, a light-blocking matrix layer 21 and a sensing circuit 3. The sensing circuit 3 is disposed on a surface of the substrate 20 and forms a single-layer structure, and is disposed at the light-blocking matrix layer 21, for example, the sensing circuit 3 is located at the vertical projection of the light-blocking matrix layer 21. To be noted, the touch display apparatus D means the display apparatus with the touch sensing electrodes, encompassing the out-cell touch display panel, the in-cell touch display panel or the touch display panel with touch on display (TOD) where the touch sensing electrodes are directly formed on the display panel. Besides, the touch display apparatus D can be any type of the flat display apparatus, such as an LCD apparatus or an electroluminescent display (ELD), as long as the touch display panel thereof includes a light-blocking matrix layer.

In this embodiment, for the convenient illustration and understanding, the touch display apparatus D is a TOD touch display apparatus for example, so the sensing circuit 3 includes the sensing electrode, while the touch display panel 2 is an LCD panel for example, including a color filter substrate and a thin film transistor substrate.

The substrate 20 can be made by transparent material, and can be a plastic or glass substrate. Of course, the substrate 20 also can be a PI (polyimide) or PET (polyethylene terephthalate) transparent substrate. Moreover, in other embodiments, the substrate 20 also can be a planarization layer (such as an inorganic layer or organic layer) of the touch display panel 2 for serving as a carrier, and therefore the sensing circuit can be formed on the substrate which serves as the planarization layer. In other words, the substrate 20 can be a hard or soft substrate, or can be disposed within the display panel. However, this invention is not limited thereto.

In FIG. 1, the arrows denote the light direction of the backlight module 4. In FIG. 2, just the disposition of the substrate 20, light-blocking matrix layer 21 and sensing circuit 3 is shown. In this embodiment, the sensing circuit 3 within the touch display panel 2 is disposed on the substrate 20 and the light-blocking matrix layer 21 is disposed on the side of the substrate 20 opposite the sensing circuit 3. In other words, the light-blocking matrix layer 21 and the sensing circuit 3 are disposed on the different sides of the substrate 20. The touch display panel 2 further includes a color filter layer 22. The light-blocking matrix layer 21 and the color filter layer 22 are disposed on the same side of the substrate 20. Besides, the light-blocking matrix layer 21 is disposed around the color resist portions of the color filter layer 22 for enhancing the sub-pixel identification.

To be noted, since the sensing circuit 3 is disposed at the vertical projection of the light-blocking matrix layer 21, the cases of the sensing circuit 3 disposed on the same side (light input side) as the light-blocking matrix layer 21 and disposed on the different side (light output side) from the light-blocking matrix layer 21 are both encompassed in the scope of this invention.

FIGS. 3A and 3B are schematic diagrams showing the sensing circuit of a single pitch of the touch display panel, and FIG. 3B is a schematic enlarged diagram of a part of FIG. 3A. For the actual product, the single-layer sensing circuit 3 of the touch display panel can include a plurality of the structures shown in FIG. 3A.

The sensing circuit 3 includes a plurality of driving electrodes 32, a plurality of sensing electrodes 31 and a plurality of signal wires 34, and can further include a plurality of grounding electrodes 33 which are disposed between and insulated from the driving electrodes 32 and the sensing electrodes 31.

For the convenient understanding, the detailed electrode pattern of the sensing circuit 3 is not shown in FIG. 3A. It can be found in FIG. 3A that the driving electrodes 32 and the sensing electrodes 31 of the sensing circuit 3 are arranged in one dimension, and they are disposed adjacent to each other and insulated from each other. The driving electrodes 32 and the sensing electrodes 31 are electrically connected to the control unit 5, which is disposed on a side, through the signal wires 34. When the user touches or clicks the touch display apparatus D, the capacitance variation signal caused by the driving electrode 32 is received by the sensing electrode 31 and transmitted to a signal processing module of the control unit 5 electrically connected to the sensing electrode 31, and then is processed so that a coordinate signal representing the touch input can be obtained. The driving sensing method of the driving and sensing electrodes 32 and 31 can be a mutual capacitive type. In other applications, the driving sensing method of the driving and sensing electrodes 32 and 31 can be a self capacitive type, indicating the driving and sensing electrodes 32 and 31 can sense the touch and transmit the touch signal by themselves. The driving and sensing electrodes 32 and 31 and the signal wires 34 are made by conductive material and can be formed on a single layer (i.e. the same layer) by a semiconductor or printing process, and can be held by the substrate 20 so as to form a single electrode layer.

To be noted, the driving and sensing electrodes 32 and 31 and the signal wires 34 are distributed by the layout circuit 30 disposed at the vertical projection of the light-blocking matrix layer 21. With the different design, the driving and sensing electrodes 32 and 31 and the signal wires 34 distributed by the layout circuit 30 will have different patterns. So, different patterns of the driving and sensing electrodes 32 and 31 and signal wires 34 can be formed. In one embodiment, the pattern of the sensing circuit 3 is similar to a metal mesh, wherein the driving and sensing electrodes 32 and 31 can form a plurality of nodes, and at least one node is formed by connecting at least three sensing electrodes.

In this embodiment, the patterns of the driving and sensing electrodes 32 and 31 include rectangular shapes as well as comb shapes for example. The wire width of the layout circuit 30 of the driving and sensing electrodes 32 and 31 and signal wires 34 is between 3 μm and 50 μm and favorably between 5 μm and 20 μm.

According to the above illustration, the signal wires 34 are electrically connected to the driving electrodes 32 or the sensing electrodes 31, and the grounding electrodes 33 are disposed within the intervals of the driving electrodes 32 or sensing electrodes 31. In order to achieve the impedance matching (avoiding the signal wire width of the impedance matching from being larger than the area of the whole metal circuit), the signal wires 34 can further include at least a branch of the layout circuit 30, that means the layout circuit 30 of the signal wires 34 is distributed to the location of the light-blocking matrix disposed on the two sides of at least a sub-pixel for increasing the area of the current passing through. Besides, when being farther from the control unit 5 which is disposed on the edge, the signal wires 34 have the more branches and the area is increased. In other words, when being closer to the control unit 5, the signal wires 34 require the less branches of the layout circuit 30. Accordingly, the problem of the conventional art that the thicker signal wires need to applied to the farther electrodes and the thinner signal wires need to be applied to the closer electrodes can be solved, and therefore the whole cost can be reduced and the assembly speed can be raised.

To be noted, the described single-layer indicates that the driving electrodes 32, the sensing electrodes 31, the grounding electrodes 33 and the signal wires 34 are all disposed on the same surface. For example, they are disposed on the same surface of the substrate 20 by the same sputtering process, and then etched to form the sensing circuit 3, and therefore the driving electrodes 32, the sensing electrodes 31, the grounding electrodes 33 and the signal wires 34 won't overlap with each other. Accordingly, the number of the photomask, the etching time and the bridge disposition all required for the double-layer touch electrode of the conventional art can be saved and reduced.

The driving electrodes 32, the sensing electrodes 31, the grounding electrodes 33 and the signal wires 34 are all disposed at the projection of the light-blocking matrix layer 21. The projection of the light-blocking matrix layer 21 means an imaginary surface that is formed when the light-blocking matrix layer 21 is illuminated by a parallel light along the vertical direction. Since the driving electrodes 32, the sensing electrodes 31, the grounding electrodes 33 and the signal wires 34 are all disposed at the projection of the light-blocking matrix layer 21 and the area of the light-blocking matrix layer 21 occupies about 40% of the whole effective display area, the area of the driving electrodes 32, sensing electrodes 31, grounding electrodes 33 and signal wires 34 will also occupies about 40% of the effective display area at most.

Hence, the sensitivity of the touch display apparatus can be enhanced by increasing the coverage of the driving electrodes 32 and sensing electrodes 31. Besides, since the driving electrodes 32, the sensing electrodes 31, the grounding electrodes 33 and the signal wires 34 are all disposed at the projection of the light-blocking matrix layer 21, they won't block the light output of the touch display panel 2, and therefore the light penetration loss caused by using ITO as the sensing electrode in the conventional art can be reduced.

Furthermore, the material of the sensing circuit 3 can be conductive material, such as gold, silver, copper, tin, molybdenum, aluminum, alloy, graphite, graphene or their any combination, and the resistances of the above-mentioned materials are all less than the resistance of the metal oxide so that the RC loading of the sensing circuit 3 can be reduced and the whole efficiency can be enhanced. In this embodiment, at least 70% of the area of the driving and sensing electrodes 32 and 31 is located at the projection of the light-blocking matrix layer 21, but the above percentage can be adjusted according to different requirements. In other words, the driving and sensing electrodes 32 and 31 can be all disposed at the projection of the light-blocking matrix layer 21, or a part of the driving and sensing electrodes 32 and 31 is not disposed at the projection of the light-blocking matrix layer 21.

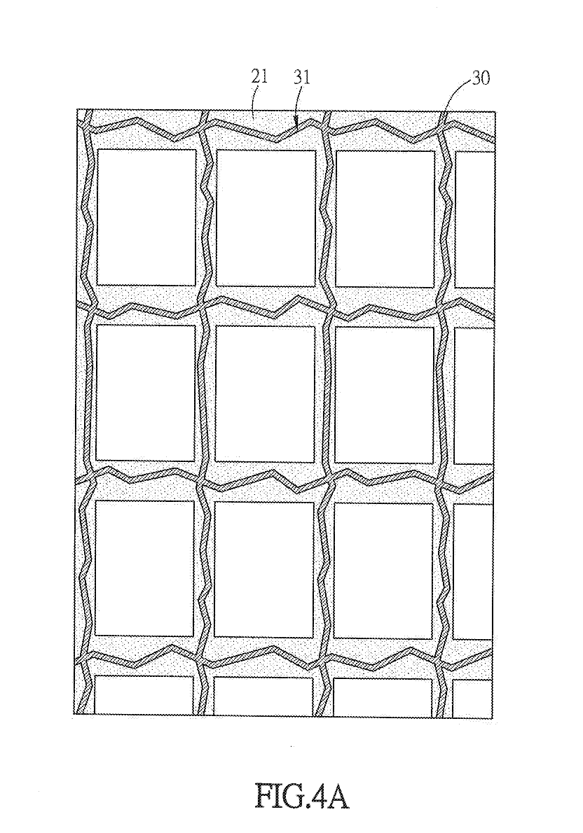

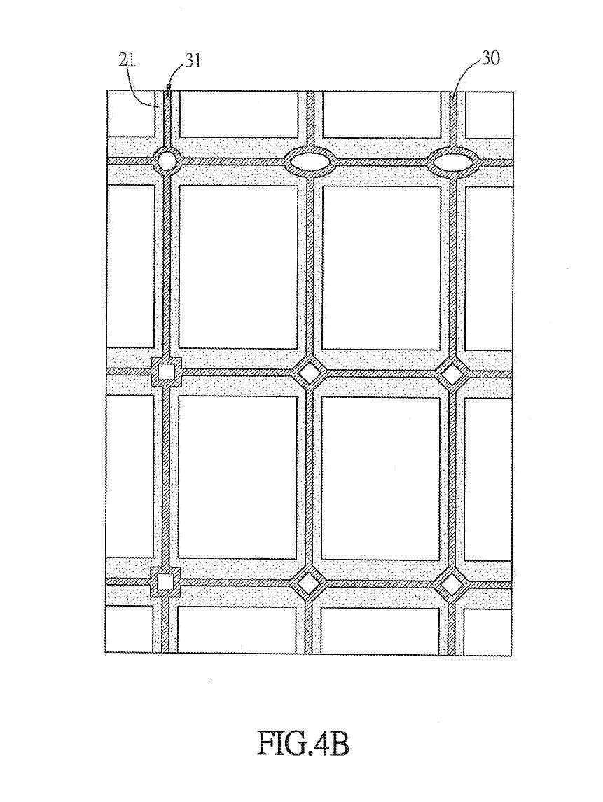

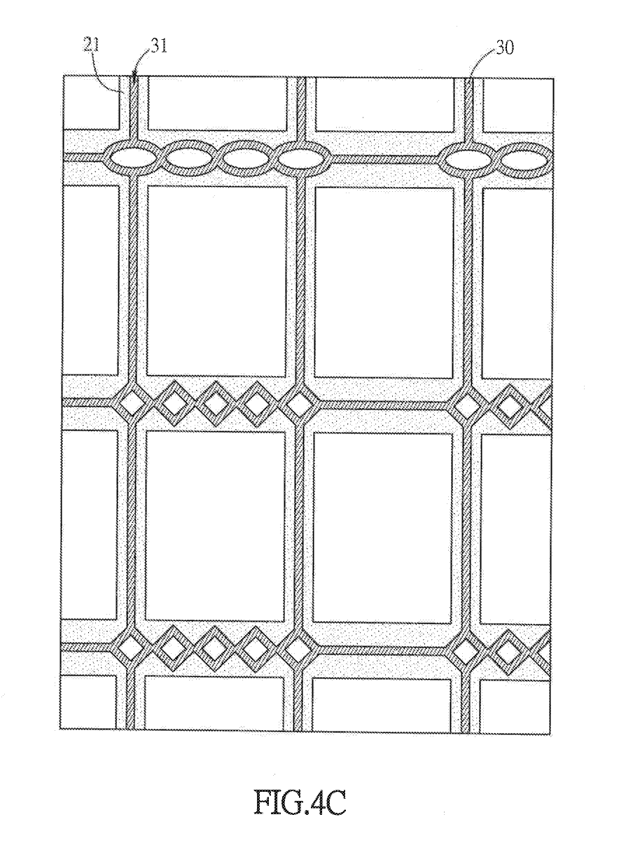

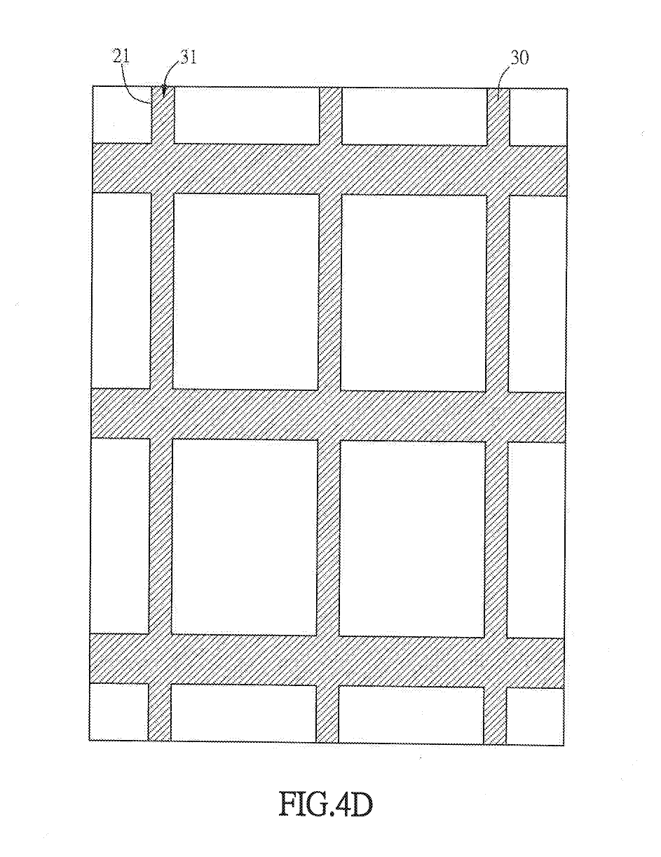

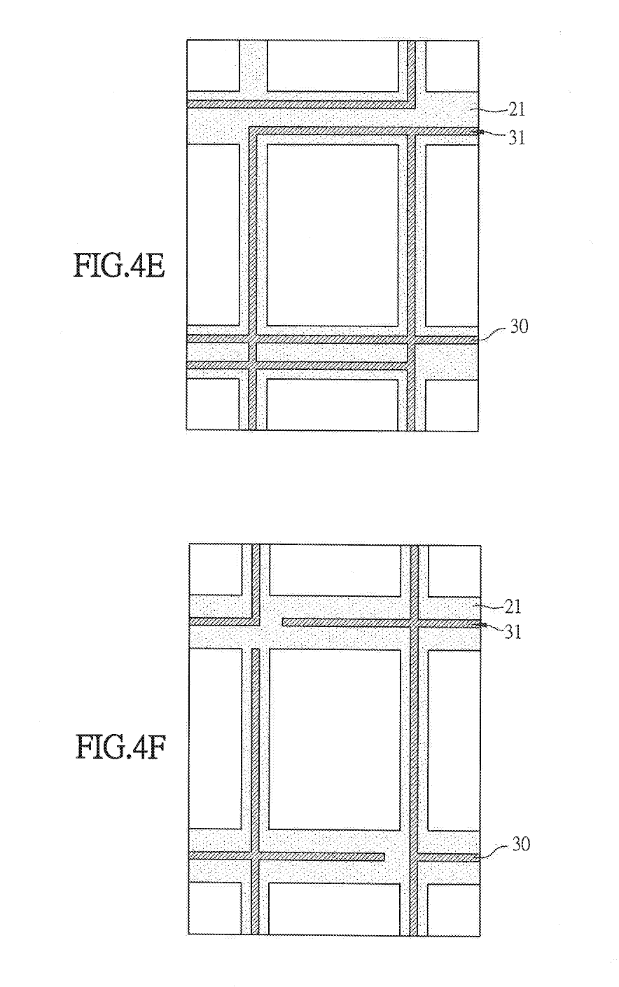

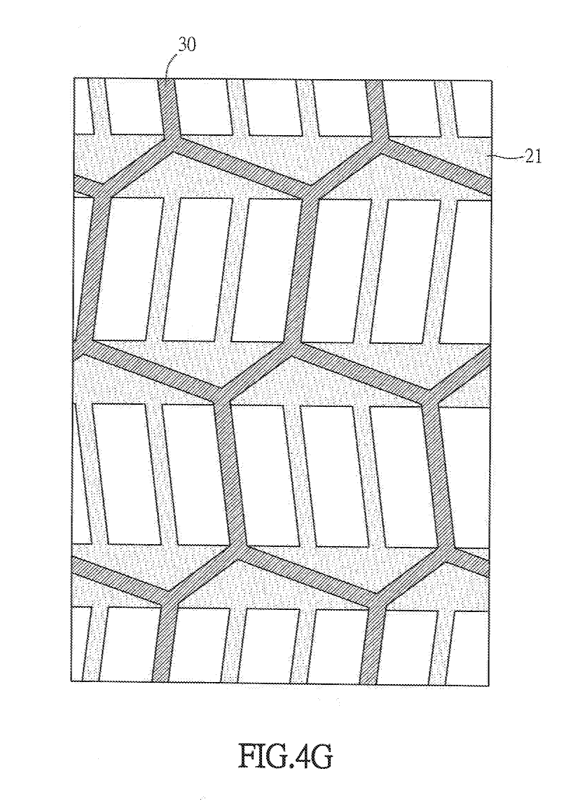

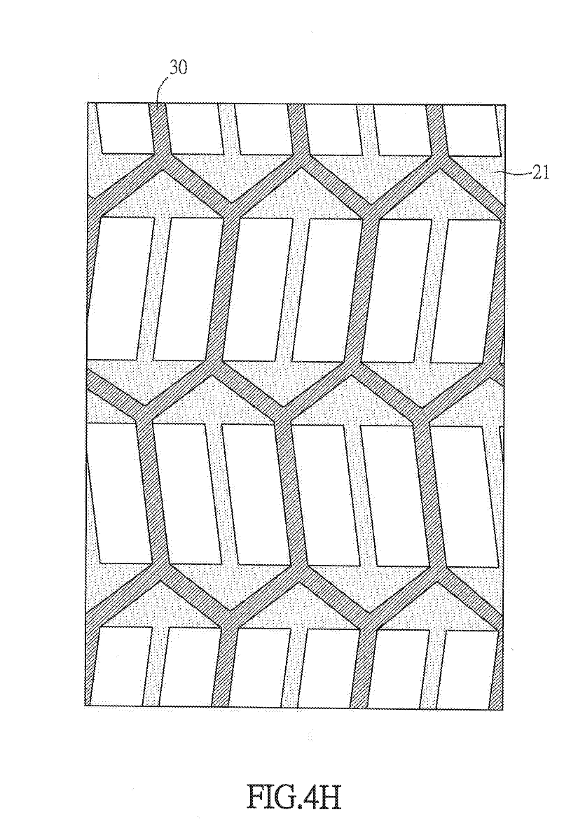

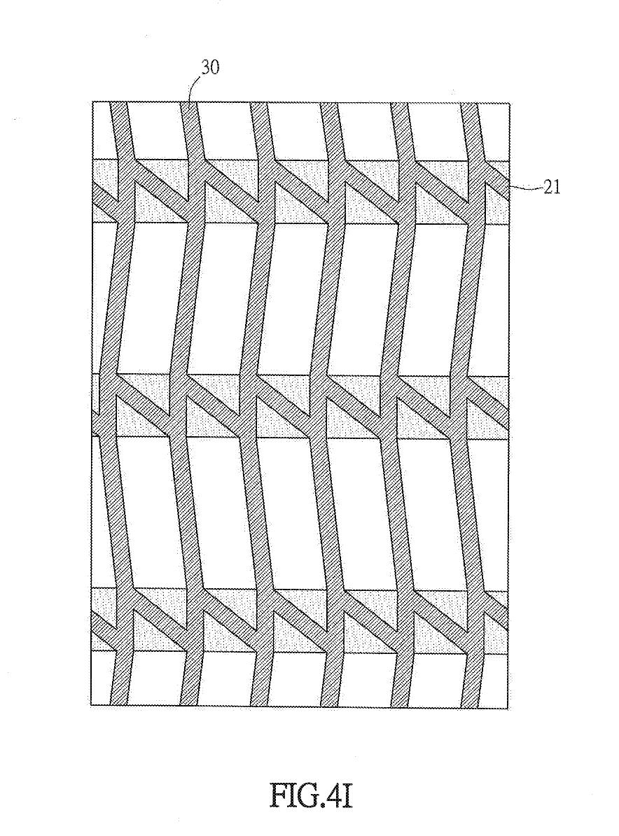

FIGS. 4A to 4I are schematic diagrams of different embodiments of the sensing circuit 3 of the touch display panel 2 in FIG. 2, and FIGS. 4E and 4F are partially enlarged diagrams for the clear illustration.

Accordingly, the driving electrodes 32, the sensing electrodes 31 and the signal wires 34 are disposed at the projection of the light-blocking matrix layer 21. Therefore, the driving electrodes 32 and the sensing electrodes 31 can be arranged with a rectangular shape, “ [symbol] ” or comb shape (as shown in FIG. 3B) or honeycomb at the projection of the light-blocking matrix layer 21 according to the size and pattern of the sub-pixel and the pattern of the light-blocking matrix layer 21. The pattern of the layout circuit 30 including the driving electrode 32 and the sensing electrode 31 includes an opening (as shown in FIGS. 4E, 4F), a toothed shape, a lightning shape, a polygonal shape, a closed contour or their any combination (as shown in FIGS. 4A, 4C, 4D) for example. Otherwise, the driving electrode 32 and the sensing electrode 31 can occupy the all range of the light-blocking matrix layer (as shown in FIG. 4D). The pattern of the layout circuit 30 can include a closed contour, an open curve, a net structure, a branched structure or their any combination for example. For clearly showing the opening, FIGS. 4E and 4F are schematic partially enlarged diagrams. The opening in there means that the plurality of connecting wires includes a broken wire between two adjacent nodes.

To be noted, the above-mentioned “ [symbol] ” shape, comb shape, honeycomb shape or opening formed by a partially break-off design can reduce the coverage of the driving electrode 32 and sensing electrode 31, and therefore the coverage of the driving electrodes 32, sensing electrodes 31 and signal wires 34 can be adjusted and evened and the uniform visual effect can be thus achieved.

In this embodiment, the driving electrode 32 or sensing electrode 31 is unnecessarily disposed around each of the sub-pixels, and it can be designed according to the actual requirement, so that the layout circuit 30 of the driving electrodes 32 and sensing electrodes 31 can be distributed to the vertical projection of the light-blocking matrix layer 21 disposed around the integral sub-pixels. For example, the layout circuit 30 of the sensing electrode 31 in FIGS. 2 and 4H is correspondingly disposed around two sub-pixels. Otherwise, as shown in FIG. 4G, the layout circuit 30 of the driving electrode 32 and sensing electrode 31 is correspondingly disposed around three sub-pixels. Otherwise, as shown in FIG. 4I, the layout circuit 30 of the driving electrode 32 and sensing electrode 31 is correspondingly disposed around a sub-pixel, and the layout circuit 30 of the driving electrode 32 and sensing electrode 31 is different from the light-blocking matrix layer 21 in distribution (partial segments of the electrodes and signal wires are not parallel to the partial segments of the light-blocking matrix layer) so that a better visual effect can be provided.

The patterns shown in the figures are just for the illustrative purpose, and the actual pattern design and disposition can be adjusted according to different requirements. Besides, the foregoing embodiments of the invention can be combined to achieve different coverage so as to increase the sensing area.

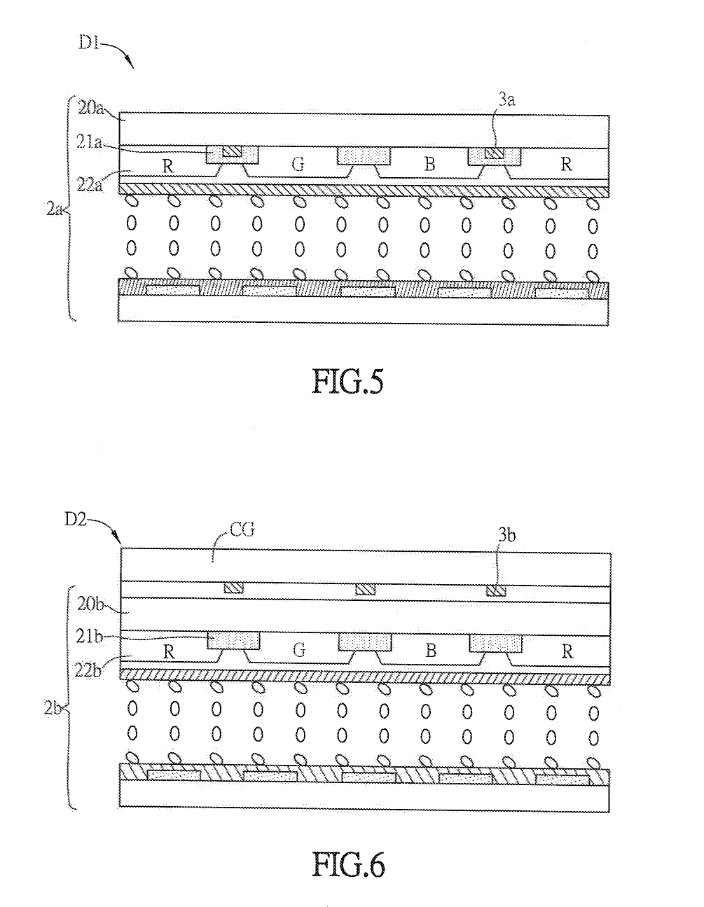

FIGS. 5 and 6 are schematic sectional diagrams of two different embodiments of the touch display apparatus of the invention.

As shown in FIG. 5, the difference between the embodiment of FIG. 5 and the foregoing embodiments is that the touch display apparatus D1 of this embodiment is an in-cell touch display apparatus where the light-blocking matrix layer 21a of the touch display panel 2a is disposed on a side (light input side) of the substrate 20a and the sensing circuit 3a is also disposed on the side of the substrate 20a (in other words, the light-blocking matrix layer 21a and the sensing circuit 3a are disposed on the same side). Moreover, the embodiment can be made by different methods according to different requirements. For example, the sensing circuit 3a is first formed on the inner side of the color filter layer 22a and then covered by a planarization layer (not shown), and then the light-blocking matrix layer 21a and the color resist portions of the color filter layer 22a are formed. Otherwise, the light-blocking matrix layer 21a and the color resist portions of the color filter layer 22a are formed first on the inner side of the color filter layer 22a and then covered by a planarization layer, and then the sensing circuit 3a is formed.

As shown in FIG. 6, the difference between the embodiment of FIG. 6 and the foregoing embodiments is that the touch display apparatus D2 of this embodiment is an out-cell touch display apparatus and also an OGS (one glass solution) touch display apparatus. In this embodiment, the touch display apparatus D2 further includes a cover glass CG and a touch display panel 2b disposed opposite the cover glass CG. The cover glass CG is used as the substrate in this embodiment, so the sensing circuit 3b is disposed on a light input side of the cover glass CG, i.e. the lower surface of the cover glass CG. The touch display panel 2b is disposed on a light input side of the cover glass CG, and the light-blocking matrix layer 21 of this embodiment is disposed within the touch display panel 2b. To be noted, the above-mentioned touch display panels 2a, 2b are both vertical driving touch display panels for example, so there is still a common electrode layer disposed between the sensing circuit 3b and the liquid crystal. When the touch display panel is illustrated as the horizontal driving type, such as an IPS display panel, since there is no common electrode layer, an additional electrical covering layer needs to be made between the sensing circuit 3b and the liquid crystal to avoid the mutual signal interference between the sensing circuit 3b and the pixel electrode.

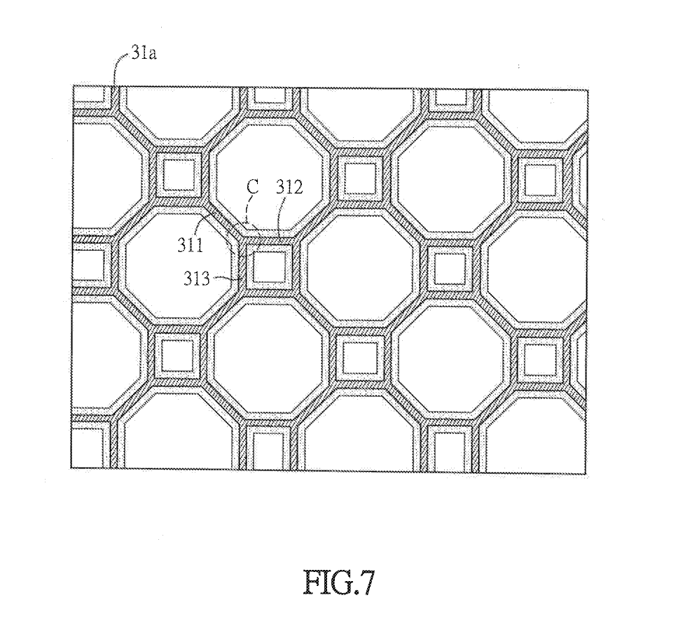

FIG. 7 is a schematic enlarged diagram of a part of the sensing circuit of the touch display panel according to another embodiment of the invention, just showing the sensing circuit 31a. Similar to the above embodiment, the touch display panel of this embodiment includes the substrate, the light-blocking matrix layer (not shown) and the sensing circuit 31a. The sensing circuit 31a is disposed on a surface of the substrate and forms a single-layer structure. The sensing circuit 31a of this embodiment is also disposed at the light-blocking matrix layer (not shown), so it will not block the light output of the touch display panel and the light penetration loss caused by using ITO as the sensing electrode in the conventional art can be reduced. In other embodiment, at least 70% of the area of the sensing circuit 31a is located at the projection of the light-blocking matrix layer 21, but the above percentage can be adjusted according to different requirements, so the pattern of the sensing circuit 31a can be different from the pattern of the light-blocking matrix layer 21. In other words, the sensing circuit 31a can be all disposed at the projection of the light-blocking matrix layer 21, or a part of the sensing circuit 31a is not disposed at the projection of the light-blocking matrix layer 21.

Different from the above embodiment, the light-blocking matrix layer can be arranged with a honeycomb shape or diamond shape. Besides, the design of the honeycomb and diamond shape can reduce the reflection of the sensing circuit 31a, in comparison with the design of rectangular shape.

As shown in FIG. 7, the sensing circuit 31a includes a plurality of sensing electrodes which include a plurality of connecting wires 311, 312, 313 forming a plurality of nodes C, and at least one of the nodes C is formed by three of the connecting wires 311, 312, 313. Besides, any two included angles formed by the three connecting wires 311, 312, 313 are the same or different. For example, the included angle between the connecting wires 311 and 312 is the same as that between the connecting wires 312 and 313. However, the above included angle can be adjusted according to different visual effect in this invention, and the included angles can be different.

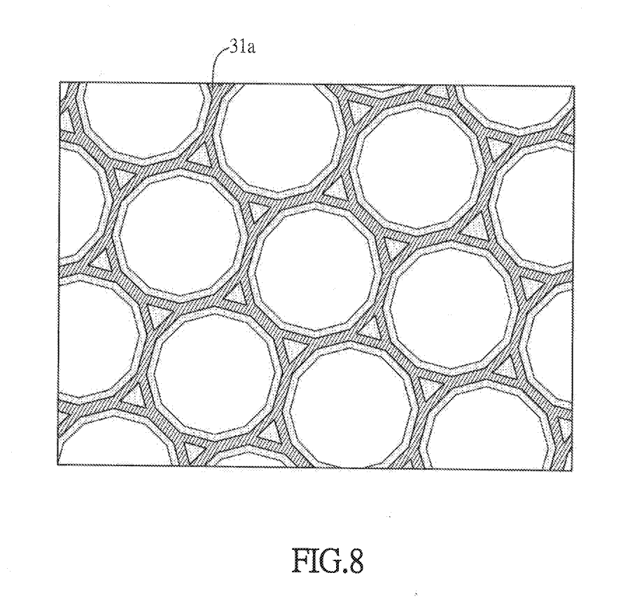

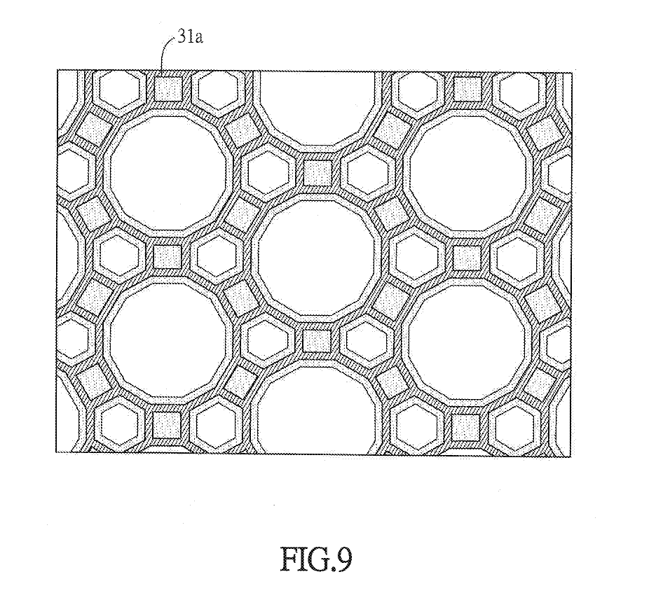

FIGS. 8 and 9 are schematic diagrams of the sensing circuit of the touch display panel according to other two embodiments of the invention. In addition to the pattern of FIG. 7, the light-blocking matrix layer 21c also can be arranged with the patterns shown in FIGS. 8 and 9, and the sensing circuit 31a is disposed at the vertical projection of the light-blocking matrix layer 21c to achieve the similar effect to the above embodiment.

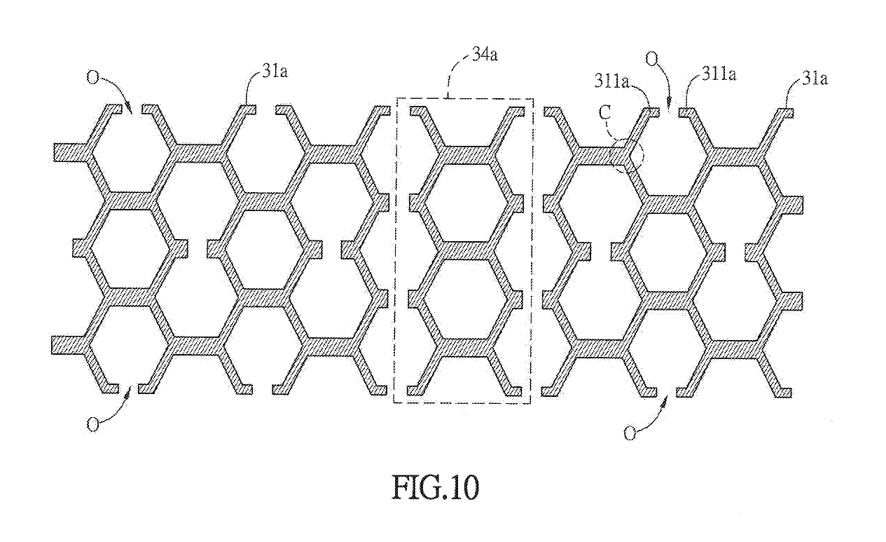

FIG. 10 is a schematic diagram of the sensing circuit of the touch display panel according to another embodiment of the invention.

The sensing circuit of this embodiment further includes a plurality of signal wires 34a connected to the sensing electrodes 31a, and the sensing electrodes 31a and the signal wires 34a are disposed at the single-layer structure. The sensing electrode 31a doesn't overlap the signal wire 34a. At least a part of the signal wires 34a is disposed between the two adjacent sensing electrodes 31a and insulated from the two adjacent sensing electrodes 31a. Moreover, at least a part of the signal wires 34a of this embodiment is disposed at the projection of the light-blocking matrix layer (not shown).

As shown in FIG. 10, at least a part of the sensing electrodes 31a of this embodiment forms at least an opening O. In other words, the sensing electrodes 31a can be partially broken off to form the appearance like an opening. The opening O means that the plurality of connecting wires 311a includes a broken wire between two adjacent nodes C. The design of at least one opening O can reduce the coverage of the sensing electrodes 31a and even the coverage of the sensing circuit of the panel so as to achieve the uniform visual effect and enhance the visual effect.

Summarily, in the touch display panel and touch display apparatus of the invention, the single-layer sensing circuit is formed at the projection of the light-blocking matrix layer, so the area of the sensing circuit can be increased without increasing the light penetration loss. Therefore, the sensitivity of the touch display panel and apparatus can be enhanced, the whole RC loading can be reduced and the entire efficiency can be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A touch display panel, comprising:
a substrate;
a light-blocking matrix layer, and
a sensing circuit forming a single-layer structure on a surface of the substrate and located at the light-blocking matrix layer.

2. The touch display panel as recited in claim 1, wherein the sensing circuit includes:
a plurality of driving electrodes separated from each other;
a plurality of sensing electrodes separated from each other; and
a plurality of signal wires connected to the driving electrodes and the sensing electrodes, and the sensing electrodes, the driving electrodes and the signal wires are disposed on the single-layer structure.

3. The touch display panel as recited in claim 2, wherein the signal wires connected to the driving electrodes are used to receive a driving signal to sense a touch, and the sensed signal is outputted through the signal wires connected to the sensing electrodes.

4. The touch display panel as recited in claim 2, wherein a part of the signal wires has a branch.

5. The touch display panel as recited in claim 2, wherein at least 70% of the area of the driving and sensing electrodes is located at the light-blocking matrix layer.

6. The touch display panel as recited in claim 2, wherein a signal wire width of the driving electrodes, sensing electrodes and signal wires is between 3 μm and 50 μm.

7. The touch display panel as recited in claim 1, wherein the material of the sensing circuit is gold, silver, copper, tin, molybdenum, aluminum, alloy, graphite, graphene or their any combination.

8. The touch display panel as recited in claim 2, wherein the sensing circuit includes:
a plurality of grounding electrodes disposed between and separated from the driving electrodes and the sensing electrodes.

9. The touch display panel as recited in claim 2, wherein the driving electrodes and the sensing electrodes are arranged with a rectangular shape, “ [symbol] ” shape, comb shape or their any combination.

10. The touch display panel as recited in claim 2, wherein the sensing electrodes, the driving electrodes and the signal wires are composed of a layout circuit located at the light-blocking matrix layer.

11. The touch display panel as recited in claim 10, wherein the shape of the layout circuit includes an opening, a toothed shape, a lightning shape, a polygonal shape, a closed contour or their any combination, or occupies the all range of the light-blocking matrix layer.

12. The touch display panel as recited in claim 10, wherein the pattern of the layout circuit includes a closed contour, an open curve, a net structure, a branched structure or their any combination.

13. The touch display panel as recited in claim 1, wherein the light-blocking matrix layer is disposed on another surface of the substrate.

14. The touch display panel as recited in claim 1, wherein the light-blocking matrix layer is disposed on the surface of the substrate.

15. The touch display panel as recited in claim 1, further comprising:
a display panel disposed on a light input side of the substrate, wherein the light-blocking matrix layer is disposed within the display panel.

16. A touch display apparatus, comprising:
a touch display panel as recited in claim 1;
a backlight module disposed on a side of the touch display panel; and
at least a control unit electrically connected to the sensing circuit.

17. A touch display panel, comprising:
a substrate;
a light-blocking matrix layer; and
a sensing circuit forming a single-layer structure on a surface of the substrate, wherein the sensing circuit includes a plurality of sensing electrodes,
wherein the sensing electrode includes a plurality of connecting wires,
wherein at least one node is formed by connecting three of the connecting wires.

18. The touch display panel as recited in claim 17, wherein any two included angles formed by the three connecting wires are different.

19. The touch display panel as recited in claim 17, wherein the plurality of connecting wires includes a broken wire between two adjacent nodes.
